(19) United States
(12) Patent Application Publication
(10) Pub. No.: US 2014/0056236 A1
(43) Pub. Date: Feb. 27, 2014

(54) Methods and Devices for Uplink MIMO Operation

(71) Applicant: Telefonaktiebolaget L M Ericsson (publ), Stockholm (SE)

(72) Inventors: Johan Bergman, Stockholm (SE); Johan Hultell, Solna (SE)

(73) Assignee: TELEFONAKTIEBOLAGET L M ERICSSON (PUBL), Stockholm (SE)

(21) Appl. No.: 13/822,108

(22) PCT Filed: Nov. 21, 2012
(86) PCT No.: PCT/SE2012/051285

§ 371 Date: Mar. 11, 2013

Related U.S. Application Data
(60) Provisional application No. 61/577,757, filed on Dec. 20, 2011.

(51) Int. Cl. H04W 72/12

(52) U.S. Cl. CPC H04W 72/1268; H04W 72/1231
USPC 370/329

(57) ABSTRACT

In a radio system configured for uplink Multiple Input Multiple Output, MIMO, operation, methods and devices are provided that transmits an indicator signal indicating whether the UE has scheduled data for transmission on a secondary stream. The indicator signal is transmitted on an E-DCH Dedicated Physical Control Channel, E-DPCCH, associated with a primary stream.

### TECHNICAL FIELD

The present disclosure relates to a method and an apparatus for MIMO transmission in a radio network.

### BACKGROUND

Today's mobile communication systems are evolving rapidly. In connection to the standardization efforts for Wideband Code Division Multiple Access (WCDMA)/High Speed Packet Access (HSPA) Release 10, the third generation partnership project (3GPP) evaluated open loop beam forming and open loop antenna switching for uplink transmissions in WCDMA/HSPA. Both of these techniques are based on that a User Equipment (UE) with multiple transmit antennas exploits the existing feedback, e.g. Fractional Dedication Control Channel (F-DPCH) or Enhanced Dedicated Channel (E-DCH) HARQ Acknowledgement Indicator Channel (E-HICH) to determine a suitable precoding vector in an autonomous fashion with the purpose to maximize the signal to noise plus interference ratio (SIR) at the receiving Node-B. Since the network is unaware of the applied precoding weights the Node-Bs will experience a discontinuity in the measured power when a change in precoding weights occurs. Precoding in multiple-input-multiple-output transmission is also described e.g. on page 252 in the book “3G Evolution: HSPA and LTE for Mobile Broadband” (second edition) by Dahlman et. al.

Since then there have been proposals for introducing closed loop transmit diversity (both for closed loop beam forming and for closed loop antenna switching) for WCDMA/HSPA. Contrary to the open loop techniques where the UE decides precoding weights, closed loop techniques are based on that the network, e.g. the serving Node-B, selects the suitable precoding vector with which the signal is multiplied. In order to signal the necessary feedback information from the network to the UE the Node-B can either rely on one of the existing physical channels (e.g., F-DPCH) or a new feedback channel could be introduced. A work item for closed loop transmit diversity was started at RAN#50, see 3GPP Tdoc RP-101438, Work Item Description for “Uplink (Open-Loop and Closed-Loop) Transmit Diversity for HSPA”

Uplink multiple-input-multiple-output (MIMO) transmission is a related technique that has been proposed as a 3GPP release 11 (Rel-11) candidate for WCDMA/HSPA. A study item on uplink MIMO was started at RAN#50, see 3GPP Tdoc RP-101432, Study Item Description for “UL MIMO for HSPA” and a work item was started at RAN#54, see 3GPP Tdoc RP-111642, Work Item Description for “MIMO with 64 QAM for HSUPA”.

In uplink MIMO different data can be transmitted in more than one stream. It should be noted that closed loop beam forming can be viewed as a special case of uplink MIMO where no data is scheduled in one of the streams. MIMO technology is mainly beneficial in situations where the composite channel is strong and has high rank. The rank of a channel is the momentary number of parallel data streams that a MIMO channel is (currently) able to support. Here we include the effects of transmit antenna(s), and the radio channel between the transmitting and receiving antennae in the term. However in situations where the rank of the composite channel is low (e.g. where there is a limited amount of multi-path propagation and cross polarized antennas are not used) and/or the path gain is weak, then single stream transmissions (beam forming techniques) are generally preferable. This is a combined effect of that the (theoretical) gain of MIMO transmission is marginal at low SIR operating point and that the inter-stream interference can be avoided (reduced) in case of single-stream transmissions.

FIG. 1 and FIG. 2 show two possible UE architectures for a UE configured in MIMO mode. In FIG. 1 an exemplary of UE architecture that can support uplink MIMO is depicted. Here the parts with solid border/lines before the summation points correspond to one stream and the parts with dashed border/lines before the summation points correspond to the other stream. The primary E-DPCCH is preferably mapped to the same stream as P-DPCCH (similar to earlier 3GPP releases), while the secondary E-DPCCH could either be mapped to the primary or the secondary stream (two alternative standard design choices). The pilot field of DPCCH is specified in 3G TS 25.211 V10.0.0 subclause 5.2.1.1. P-DPCCH and S-DPCCH have similar pilot fields but mapped to different streams as in FIG. 1 or to different antennas as in FIG. 2. In FIG. 2 another exemplary UE architecture that can support uplink MIMO is shown. In FIG. 3 the primary Downlink Physical Control Channel (P-DPCCH) pilot signal and the secondary Downlink Physical Control Channel (S-DPCCH) pilot signal are precoded with the same precoding vectors as used for precoding the other physical channels transmitted on each respective stream. The primary DPCCH (P-DPCCH) may alternatively be referred to as DPCCH. In FIG. 2 the P-DPCCH and S-DPCCH are not precoded. Here a stream is defined by the precoding vector. All physical channels that are multiplied with the same precoding vector are said to belong to the same stream.

In the following a primary stream will refer to a stream that the UE starts allocating Enhanced Dedicated Channel (E-DCH) data to. This is also known as the primary beam or the primary virtual antenna. The secondary stream will refer to another stream, which the UE does not start to allocate data to. This is also known as a secondary beam or a secondary virtual antenna.

For the case when P-DPCCH is precoded with the same precoding vector as used for precoding the other physical channels transmitted on the primary stream, it makes sense to equal the primary DPCCH with the DPCCH that is already present in earlier 3GPP WCDMA/HSPA releases, which means that all uplink physical channels that are already present in earlier 3GPP releases are mapped to the primary stream. The UE will then first map data to the primary stream (before mapping any data to the secondary stream) similarly to how data is mapped to the single stream available in earlier releases.

For multi-antenna transmissions it is typically advantageous that the network (e.g., a serving Node-B) can acquire knowledge about the wireless channels. This is needed to both determine the rank of the channel and the suitable pre-coding vectors. Assuming that the transmit power associated with the P-DPCCH is P_{P-DPCCH} and that the power associated with the S-DPCCH is P_{S-DPCCH}=δ·P_{P-DPCCH}, let

$$H = [ \begin{matrix}{h}_{11} & {h}_{12} \\ {h}_{21} & {h}_{22}\end{matrix} ] \qquad ( 1 )$$

denote the channel matrix (here h₁₂ denotes the wireless channel between the transmit antenna 2 and receive antenna 1) and

$$Ω = [ \begin{matrix}κ & 0 \\ 0 & η\end{matrix} ] \qquad ( 2 )$$

be a matrix summarizing the inaccuracies of the power amplifiers (PAs). Note that κ is a random variable that describes the inaccuracy associated with the first (upper) transmit branch while η is a random variable describing the inaccuracy of the PA associated with the second transmit branch. Finally also let

$$W = [ \begin{matrix}{w}_{1} & {w}_{3} \\ {w}_{2} & {w}_{4}\end{matrix} ] \qquad ( 3 )$$

represent the pre-coding matrix. Here [w₁ w₂] is the primary pre-coding vector applied to the P-DPCCH. With these notations the received signal at the Node-B [r₁ r₂] can be written as

r=H·Ω·W·diag([1 δ])·s (4)

where s=[s₁(t) s₂(t)]^{T} are two pilot signals. From the equation above it is apparent that the Node-B needs to be aware of the relative power difference between Primary DPCCH (P-DPCCH) and Secondary DPCCH (S-DPCCH). To ensure that serving and non-serving Node-B have knowledge regarding this power difference the used power difference either needs to be signaled by UE or kept constant with a single inner loop power control (ILPC) loop to control the transmit power of both the P-DPCCH and the S-DPCCH.

Based on the estimated composite channel the radio base station also referred to as a Node-B will for UEs configured uplink MIMO transmissions dynamically decide:
whether rank-1 (single-stream) or rank-2 (dual-stream) transmissions are preferred, and
the preferred pre-coding vectors for the primary and secondary streams.

Note that both these decisions will take place on a dynamic basis and they can be based on several parameters such as radio conditions, UE buffers, hardware load at the Node-B, etc. With a solution where the transport block formats (e.g. the transport block sizes) on the two streams can be different there will be a need to for the UE transmit two E-DPCCHs; one for each transport block. In legacy operation where the UE only can transmit one transport block per carrier the Node-B will blindly try to decode the E-DPCCH for that UE if it has been allocated a grant. Given that the Node-B is able to decode the E-DPCCH it will use this information to decode the E-DPDCH transmissions. However, if the radio base stations Node-Bs do not know whether or not a UE configured in MIMO mode will use single or dual stream transmissions it will be necessary to blindly try to decode the E-DPCCHs belonging to both streams. This will increase the hardware resources consumed by a UE configured in uplink MIMO mode and it will thus reduce the Node-B capacity.

Each E-DPCCH slot contains 10 information bits, see 3GPP Technical specification TS 25.211, “Physical channels and mapping of transport channels onto physical channels (FDD)” V10.0.0 subclause 5.2.1.3:
2 bits for indicating the retransmission sequence number (RSN)
7 bits for indicating the used E-TFCI, and
1 bit for the so-called happy bit.

In legacy single-carrier operation the happy bit is used to indicate to the network whether the UE is happy with its current serving grant, i.e. whether the UE could use more resources for uplink transmissions. The happy bit is set to unhappy (=0) if the following 3 criteria are met, see 3GPP TS 25.321, “Medium Access Control (MAC) protocol specification” V10.4.0 subclause 11.8.1.5:
The UE is transmitting as much scheduled data as allowed by the current serving grant on that frequency. That frequency refers to the frequency on which the happy bit is transmitted.
The UE has enough transmit power available to transmit at a higher data rate on that frequency. That frequency refers to the frequency on which the happy bit is transmitted.
Based on the same power as the one selected in the E-TFC selection to transmit data in the same TTI as the happy bit, TEBS would require more than “Happy_Bit_Delay_Condition” ms to be transmitted with the current serving grant times the ratio of active processes to the total number of processes.

If these conditions are not met the happy bit should be set to happy (=1).

As set out above a UE configured with uplink MIMO will be able to transmit either a single or dual stream transmission. This will depend on the feedback from the network. There is a constant demand for improving existing systems and to provide more efficient transmission in a cellular radio system. Hence, there is a need for a method and an apparatus that provide an improved transmission in a cellular radio system.

### SUMMARY

It is an object of the present invention to provide an improved method and apparatus for improving transmission in a radio network, in particular a MIMO enabled cellular radio network.

This object and others are obtained by the method and apparatus as set out in the appended claims.

As has been realized by the inventors, some or all of the radio base stations (Node-Bs) may be unaware of whether or not the UE will transmit one or two streams in a certain Transmission Time Interval (TTI). This can for example be the case with Node-B(s) in Soft Handover (SHO) and/or scenarios where the UE is buffer limited. It will then be necessary for the Node-B(s) to blindly try to decode E-DPCCH transmissions for both streams in each TTI. This will also require that the Node-B(s) maintain updated channel estimates for both streams if the E-DPCCHs are transmitted over different streams. This will increase the hardware and/or software complexity associated with a UE configured in MIMO mode; thus the overall capacity of the Node-B will be reduced.

In accordance with embodiments described herein methods and devices are provided which allow a cellular network to decide whether or not there is data scheduled on the secondary stream by only decoding the physical channels associated with the primary stream.

In accordance with one embodiment a method for use in a User Equipment (UE) is provided. The UE is configured for uplink Multiple Input Multiple Output (MIMO) operation in which the UE may transmit a primary stream and at least one secondary stream. In accordance with the method an indicator signal is transmitted to indicate whether the UE has scheduled data for transmission on said at least one secondary stream. The indicator signal is transmitted on an E-DCH Dedicated Physical Control Channel (E-DPCCH) associated with the primary stream. Hereby a network in which the UE transmits is enabled to decide whether or not there is data scheduled on the secondary stream by only decoding the physical channels associated with the primary stream.

In accordance with one embodiment the indicator signal is a happy bit field set to indicate whether the UE has scheduled data for transmission on said at least one secondary stream.

In accordance with one embodiment a second happy bit field on an E-DPCCH associated with the at least one secondary stream is set to indicate whether the UE is happy with its current serving grant.

In accordance with one embodiment the second happy bit field is set to unhappy if the following three criteria are all met:

the UE is transmitting as much scheduled data as allowed by the current serving grant; and

the UE has enough transmit power available to transmit at a higher data rate; and

based on the same power as the one selected in the E-TFC selection to transmit data in the same TTI as the happy bit, TEBS would require more than “Happy_Bit_Delay_Condition” ms to be transmitted with the current serving grant times the ratio of active processes to the total number of processes.

In accordance with one embodiment the E-DPCCH associated with the at least one secondary stream is transmitted in the second stream.

In accordance with one embodiment the E-DPCCH associated with the at least one secondary stream is transmitted in the primary stream.

In accordance with one embodiment in a predetermined set of situations where the UE temporarily is not allowed to transmit the at least one secondary stream, the UE sets the use of the happy bit field on the E-DPCCH associated with the primary stream such that the happy bit field is set to indicate whether the UE is happy with its current serving grant.

In accordance with one embodiment the primary stream is the stream that the UE starts allocating E-DCH data to.

In accordance with one embodiment the at least one secondary stream is one secondary stream.

In accordance with another aspect of the disclosure a method for use in a radio base station (Node-B) communicating with a User Equipment (UE) is provided where the UE is configured for uplink Multiple Input Multiple Output, MIMO, operation. The UE may transmit a primary stream and at least one secondary stream. In accordance with the method an indicator signal is received from the UE, the indicator signal indicating whether the UE has scheduled data for transmission on said at least one secondary stream, wherein the indicator signal is received on an E-DPCCH associated with the primary stream. Hereby the radio base station which is also referred to as a Node B is enabled to decide whether or not there is data scheduled on the secondary stream by only decoding the physical channels associated with the primary stream.

In accordance with one embodiment the Node B selectively decides whether to decode an E-DPCCH and/or one or more E-DPDCHs associated with the at least one secondary stream based on the received indicator signal.

In accordance with one embodiment the indicator signal is a happy bit field set to indicate whether the UE has scheduled data for transmission on said at least one secondary stream.

In accordance with one embodiment a second happy bit field received on an E-DPCCH associated with the at least one secondary stream is set to indicate whether the UE is happy with its current serving grant.

In accordance with one embodiment the second happy bit field is set to unhappy if the following three criteria are all met:

the UE is transmitting as much scheduled data as allowed by the current serving grant; and

the UE has enough transmit power available to transmit at a higher data rate; and

based on the same power as the one selected in the E-DCH Transmission Format Combination (E-TFC) selection of the UE to transmit data in the same Transmission Time Interval (TTI) as the happy bit, Total E-DCH Buffer Status (TEBS) would require more than “Happy_Bit_Delay_Condition” ms to be transmitted with the current serving grant times the ratio of active processes to the total number of processes.

In accordance with one embodiment the E-DPCCH associated with the at least one secondary stream is received in the second stream.

In accordance with one embodiment the E-DPCCH associated with the at least one secondary stream is received in the primary stream.

In accordance with one embodiment the Node B accounts for the setting of the second happy bit field when deciding whether to schedule more resources for uplink transmissions by the UE.

In accordance with one embodiment in a predetermined set of situations where the UE temporarily is not allowed to transmit the at least one secondary stream, the Node B interprets the happy bit field on the E-DPCCH associated with the primary stream such that the happy bit field is set to indicate whether the UE is happy with its current serving grant.

In accordance with one embodiment the primary stream is the stream that the UE starts allocating E-DCH data to.

In accordance with one embodiment the at least one secondary stream is one secondary stream.

The disclosure also extends to devices including a UE and a radio base station/Node B for use in a cellular radio system adapted to perform the methods as described herein. The devices can be provided with a controller/controller circuitry for performing the above processes. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

### BRIEF DESCRIPTION OF THE DRAWINGS

The present invention will now be described in more detail by way of non-limiting examples and with reference to the accompanying drawings, in which:

FIGS. 1 and 2 show two possible UE architectures for a UE configured in MIMO mode,

FIG. 3 depicts a system model of a transmitter with precoding,

FIG. 4 is a general view of a cellular radio system,

FIG. 5 is a flowchart illustrating some procedural steps performed when transmitting a happy bit in a MIMO enabled UE,

FIG. 6 is a flowchart illustrating some procedural steps performed when receiving MIIMO signaling in a radio base station,

FIG. 7 is a general view of a UE, and

FIG. 8 is a general view of a radio base station.

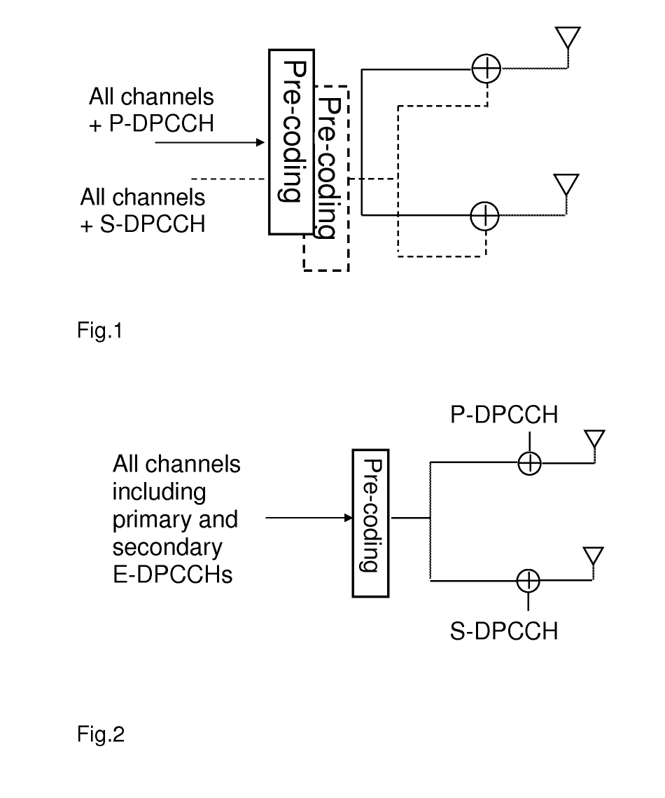

### DETAILED DESCRIPTION

In FIG. 4 a general view of a cellular radio system 100 is depicted. The system can for example be a WCDMA/HSPA system adapted for data transmission using Multiple Input Multiple Output (MIMO). The system comprises a number of radio base stations 101, here denoted NodeBs. A mobile station 103, here denoted User Equipment UE, that is in a geographical area covered by the radio base station can connect to the radio base station over an air-interface. The radio base station 101 further comprises a module 105 for performing different operations of the radio base station 101. The module 105 can for example be implemented using a microcontroller operating on a set of computer software instructions stored on a memory in the module 105. The mobile station 103 in turn comprises a module 107 adapted to perform operations of the mobile station 103. The module 107 can for example be implemented using a microcontroller operating on a set of computer software instructions stored on a memory in the module 107.

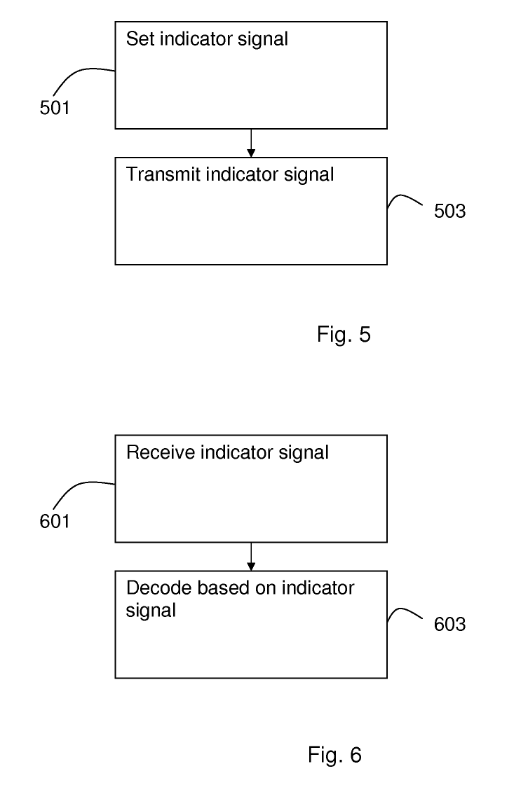

In accordance with some embodiments the radio base station 101 is adapted to interpret the happy bit transmitted on the E-DPCCH on a primary stream received from a UE 103 as an indication of whether the UE has scheduled data on the secondary stream. This can in some exemplary embodiments be achieved by adopting an E-DCH Transmission Format Combination (E-TFC) selection procedure in which the UE allocates its data to the two streams in a sequential manner and where the UE is configured to always start with the primary stream. This is illustrated in FIGS. 5 and 6.

FIG. 5 is a flow chart illustrating some procedural steps performed in a MIMO transmitting UE. The UE may transmit a primary stream and at least one secondary stream. First in a step 501 the UE sets an indicator signal indicating whether the UE has scheduled data for transmission on at least one secondary stream. Then in a step 503 the indicator signal is transmitted on an E-DPCCH associated with the primary stream.

In FIG. 6 some procedural steps performed in a radio base station, Node B, are depicted. It is assumed that the radio base station, Node-B, is communicating with a User Equipment, UE. It is further assumed that the UE is configured for uplink Multiple Input Multiple Output, MIMO, operation in which the first UE may transmit a primary stream and at least one secondary stream. In a step 601, the radio base station, Node B, receives an indicator signal from the UE on an E-DPCCH associated with the primary stream. The received indicator signal indicates whether the first UE has scheduled data for transmission on said at least one secondary stream. In accordance with some embodiments the indicator signal received in step 601 is interpreted by the radio base station, Node B, to in a step 603 selectively decide how to decode the signal received from the UE, in particular to decide whether to decode an E-DPCCH and/or one or more E-DPDCHs associated with the at least one secondary stream.

According to one embodiment, if the happy bit associated with the primary stream is
“Happy” (=1), this can be used by the radio base station, Node-B(s), as an indication that the UE has not scheduled any data on the secondary stream and that there consequently is no need to try to decode a E-DPCCH associated with a secondary stream.
“Unhappy” (=0), this can be used by the radio base station, Node-B(s), as an indication that the UE has scheduled data transmissions also on a secondary stream and that there consequently is a need to decode the E-DPCCH associated with a secondary stream.

In another embodiment the meaning of the happy bit on the primary stream is inverted so that “happy” (=1) means that a secondary stream is present while “unhappy” (=0) means that no secondary stream is present.

In accordance with some embodiments, the happy bit associated with the secondary stream can be set according to legacy procedures specified in 3GPP TS 25.321, “Medium Access Control (MAC) protocol specification” V10.4.0 subclause 11.8.1.5. This would mean that the UE is able to indicate three different cases using the happy bit:
1. “Unhappy” (=0) on a primary stream and no valid indication (e.g. a dummy value or DTX) on a secondary stream
2. “Happy” (=1) on a primary stream and happy (=1) on a secondary stream
3. “Happy” (=1) on a primary stream and unhappy (=0) on a secondary stream

In accordance with some embodiments, the happy bit field in a secondary stream is set to unhappy if the following three criteria are all met:

the UE is transmitting as much scheduled data as allowed by the current serving grant; and

the UE has enough transmit power available to transmit at a higher data rate; and

based on the same power as the one selected in the E-TFC selection to transmit data in the same TTI as the happy bit, Total E-DCH buffer status, TEBS, would require more than “Happy_Bit_Delay_Condition” ms to be transmitted with the current serving grant times the ratio of active processes to the total number of processes.

Note that the UE is not able to explicitly indicate whether it is happy or unhappy when only a primary stream is transmitted, since the happy bit on the primary stream has been given another meaning. The UE can only indicate whether it is happy or unhappy when it is transmitting (at least) two streams. However the indication can be implicitly deduced in some cases.
Assuming that the UE is allowed to transmit two streams but still chooses to transmit only a single stream, it is reasonable to assume that the UE is happy with its current serving grant since otherwise it could utilize the secondary stream (but it chose not to do this).
In case the UE is not allowed to transmit two streams and Node-B is aware of this (e.g. due to a temporary restriction imposed by Node-B and indicated to the UE e.g. via HS-SCCH orders or E-AGCH grant signaling), the UE can apply the legacy procedure for happy bit transmission on the primary stream (since there is anyway no need to indicate the presence or absence of a secondary stream in this case). In other words in this case the UE transmits and the radio base station interprets the happy bit in a conventional way.

Typically, a radio base station, Node-B, needs to be aware that the UE is configured with uplink MIMO and that the UE is using the happy bit on the E-DPCCH on the primary stream to indicate the presence or absence of an E-DPCCH on a secondary stream to make use of this information. Thus, generally only the happy bit on a secondary stream (i.e. not the happy bit on a primary stream) will be interpreted by the radio base station Node-B as an indication of whether the UE is actually happy or unhappy with the given serving grant.

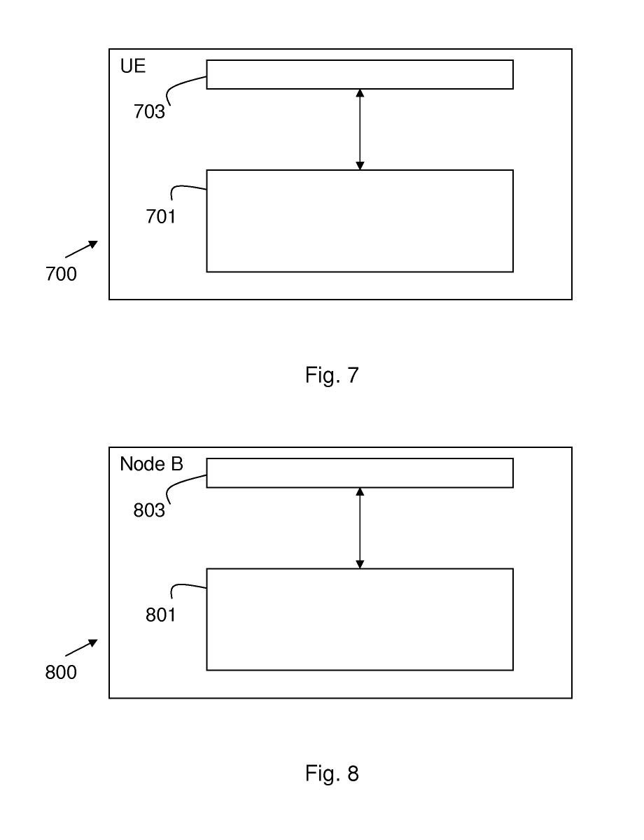

In FIG. 7 a UE 700 is schematically depicted. The UE 700 comprises controller circuitry 701 for performing all the procedures performed by the UE as described herein. The controller circuitry 701 can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor may include, without limitation, digital signal processor (DSP) hardware, ASIC hardware, read only memory (ROM), random access memory (RAM), and/or other storage media. In addition the UE 700 comprises a transceiver 703 including a transmitter and a receiver for receiving/transmitting data to the radio base station.

Further, in FIG. 8 a radio base station, Node B, 800 of a cellular radio network is schematically depicted. The radio base station 800 comprises controller circuitry 801 for performing all the procedures performed by the radio base station on the network side as described herein. The controller circuitry 801 can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media. In addition the radio base station 800 comprises a transceiver 803 including a transmitter and a receiver for receiving/transmitting data to a UE.

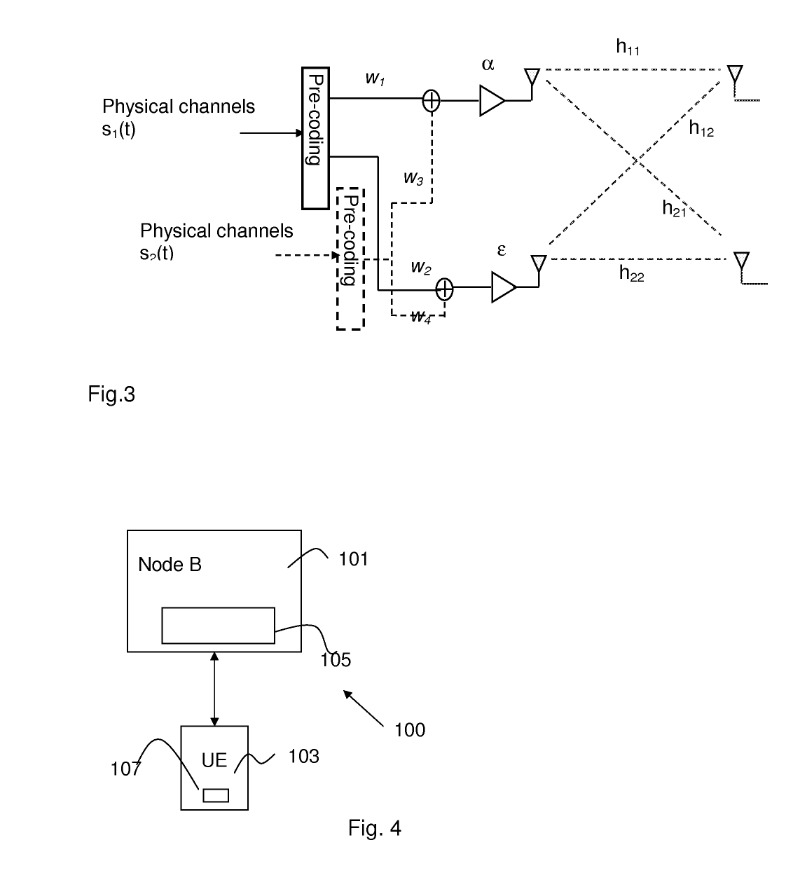

The methods and devices as described herein are applicable to both single-cell (single-carrier) and dual-cell (dual-carrier) High-Speed Uplink Packet Access (HSUPA) systems. Furthermore, although the embodiments have be described in a context of a Node-B equipped with two transmit antennas and for a UE equipped with two receive antennas and with the UE architecture described in FIG. 3, the disclosure is also applicable to settings with a larger number of transmit and receive antennas.

As set out above, the controllers of UE and Node B may generally be implemented using various kinds of digital data processing circuitry. Such circuitry can for example include (without limitation) one or more processors or Digital Signal Processors (DSPs) configured to execute computer program instructions stored in a memory (computer readable medium), Application Specific Integrated Circuits (ASICs), Field-Programmable Gate Arrays (FPGAs) or a combination thereof.

The methods and devices as described herein can enable reductions in the amount of hardware and/or software resources required in radio base stations, Node-B(s), for blind decoding of the E-DPCCH transmissions in uplink MIMO.

1-34. (canceled)

35. A method in a User Equipment (UE) configured for uplink Multiple Input Multiple Output (MIMO) operation in which the UE may transmit a primary stream and at least one secondary stream, the method comprising:
transmitting an indicator signal indicating whether the UE has scheduled data for transmission on said at least one secondary stream, wherein the indicator signal is transmitted on an E-DCH Dedicated Physical Control Channel (E-DPCCH) associated with the primary stream.

36. The method according to claim 35, wherein the indicator signal is a happy bit field set to indicate whether the UE has scheduled data for transmission on said at least one secondary stream.

37. The method according to claim 36, wherein a second happy bit field on an E-DPCCH associated with the at least one secondary stream is set to indicate whether the UE is happy with its current serving grant.

38. The method according to claim 37, wherein the second happy bit field is set to unhappy if the following three criteria are all met:
the UE is transmitting as much scheduled data as allowed by the current serving grant; and
the UE has enough transmit power available to transmit at a higher data rate; and
based on the same power as the one selected in the E-DCH Transmission Format Combination (E-TFC) selection to transmit data in the same Transmission Time Interval (TTI) as the happy bit, Total E-DCH Buffer Status (TEBS) would require more than a defined number of milliseconds of delay to be transmitted with the current serving grant times the ratio of active processes to the total number of processes.

39. The method according to claim 37, wherein the E-DPCCH associated with the at least one secondary stream is transmitted in the second stream.

40. The method according to claim 37, wherein the E-DPCCH associated with the at least one secondary stream is transmitted in the primary stream.

41. The method according to claim 36, wherein in a predetermined set of situations where the UE temporarily is not allowed to transmit the at least one secondary stream, the UE sets the use of the happy bit field on the E-DPCCH associated with the primary stream such that the happy bit field is set to indicate whether the UE is happy with its current serving grant.

42. The method according to claim 35, wherein the primary stream is the stream that the UE starts allocating E-DCH data to.

43. The method according to claim 35, wherein the at least one secondary stream is one secondary stream.

44. A method in a Node-B communicating with a User Equipment (UE) being configured for uplink Multiple Input Multiple Output (MIMO) operation in which the UE may transmit a primary stream and at least one secondary stream, the method comprising the steps of:
receiving an indicator signal from the UE, the indicator signal indicating whether the UE has scheduled data for transmission on said at least one secondary stream, wherein the indicator signal is received on an E-DCH Dedicated Physical Control Channel (E-DPCCH) associated with the primary stream.

45. The method according to claim 44, wherein the Node B selectively decides whether to decode an E-DPCCH and/or one or more E-DCH Dedicated Physical Data Channels (E-DPDCHs) associated with the at least one secondary stream, based on the received indicator signal.

46. The method according to claim 45, wherein in a predetermined set of situations where the UE temporarily is not allowed to transmit the at least one secondary stream, the Node B interprets the happy bit field on the E-DPCCH associated with the primary stream such that the happy bit field is set to indicate whether the UE is happy with its current serving grant.

47. The method according to any claim 44, wherein the indicator signal is a happy bit field set to indicate whether the UE has scheduled data for transmission on said at least one secondary stream.

48. The method according to claim 47, wherein a second happy bit field received on an E-DPCCH associated with the at least one secondary stream is set to indicate whether the UE is happy with its current serving grant.

49. The method according to claim 48, wherein the second happy bit field is set to unhappy if the following three criteria are all met:
the UE is transmitting as much scheduled data as allowed by the current serving grant; and
the UE has enough transmit power available to transmit at a higher data rate; and
based on the same power as the one selected in the E-DCH Transmission Format Combination (E-TFC) selection of the UE to transmit data in the same Transmission Time Interval (TTI) as the happy bit, Total E-DCH Buffer Status, TEBS, would require more than a defined number of milliseconds of delay to be transmitted with the current serving grant times the ratio of active processes to the total number of processes.

50. The method according to claim 48, wherein the E-DPCCH associated with the at least one secondary stream is received in the second stream.

51. The method according to claim 48, wherein the E-DPCCH associated with the at least one secondary stream is received in the primary stream.

52. The method according to claim 48, wherein the Node B accounts for the setting of the second happy bit field when deciding whether to schedule more resources for uplink transmissions by the UE.

53. The method according to claim 44, wherein the primary stream is the stream that the UE starts allocating E-DCH data to.

54. The method according to claim 44 wherein the at least one secondary stream is one secondary stream.

55. A User Equipment (UE) configurable for uplink Multiple Input Multiple Output (MIMO) operation in which operation mode the UE is enabled to transmit a primary stream and at least one secondary stream, the UE comprising:
a transmitter for performing uplink transmissions including said primary stream and at least one secondary stream;
a controller operably connected to the transmitter, wherein the controller is adapted to, when the UE is configured for uplink MIMO operation, generate an indicator signal indicating whether the UE has scheduled data for transmission on said at least one secondary stream and trigger the transmitter to transmit the indicator signal on an E-DCH Dedicated Physical Control Channel (E-DPCCH) associated with the primary stream.

56. The user equipment according to claim 55, wherein the indicator signal is a happy bit field set to indicate whether the UE has scheduled data for transmission on said at least one secondary stream.

57. The user equipment according to claim 56, wherein the controller is further adapted to generate a second happy bit field to indicate whether the UE is happy with its current serving grant and trigger the transmitter to transmit the second happy bit field on an E-DPCCH associated with the at least one secondary stream.

58. The user equipment according to claim 57, wherein the second happy bit field is set to unhappy if the following three criteria are all met:
the UE is transmitting as much scheduled data as allowed by the current serving grant; and
the UE has enough transmit power available to transmit at a higher data rate; and
based on the same power as the one selected in the E-DCH Transmission Format Combination (E-TFC) selection to transmit data in the same Transmission Time Interval (TTI) as the happy bit, Total E-DCH Buffer Status (TEBS) would require more than a defined number of milliseconds of delay to be transmitted with the current serving grant times the ratio of active processes to the total number of processes.

59. The user equipment according to claim 56 wherein in a predetermined set of situations where the UE temporarily is not allowed to transmit the at least one secondary stream, the controller is configured to set the happy bit field on the E-DPCCH associated with the primary stream such that the happy bit field is set to indicate whether the UE is happy with its current serving grant.

60. The user equipment according to claim 55, wherein the primary stream is the stream that the UE starts allocating E-DCH data to.

61. A Node B capable of communicating with a User Equipment (UE) configured for uplink Multiple Input Multiple Output (MIMO) operation in which the UE may transmit a primary stream and at least one secondary stream, the Node B comprising:
a receiver for receiving uplink transmissions including said primary stream and at least one secondary stream;
a controller operably connected to the receiver, wherein the controller is adapted to, when the UE is configured for uplink MIMO operation, interpret an indicator signal received by the receiver from the UE on an E-DCH Dedicated Physical Control Channel (E-DPCCH) associated with the primary stream, wherein the indicator signal indicates whether the UE has scheduled data for transmission on said at least one secondary stream.

62. The Node B according to claim 61, wherein the controller is configured to selectively decide whether to decode an E-DPCCH associated with the at least one secondary stream based on the received indicator signal.

63. The Node B according to claim 62, wherein in a predetermined set of situations where the UE temporarily is not allowed to transmit the at least one secondary stream, the controller is configured to interpret the happy bit field on the E-DPCCH associated with the primary stream such that the happy bit field is set to indicate whether the UE is happy with its current serving grant.

64. The Node B, according to claim 62, wherein the primary stream is the stream that the UE starts allocating E-DCH data to.

65. The Node B according to claim 61, wherein the indicator signal is a happy bit field set to indicate whether the UE has scheduled data for transmission on said at least one secondary stream.

66. The Node B according to claim 65, wherein a second happy bit field received on an E-DPCCH associated with the at least one secondary stream is set to indicate whether the UE is happy with its current serving grant.

67. The Node B according to claim 66, wherein the second happy bit field is set to unhappy if the following three criteria are all met:
the UE is transmitting as much scheduled data as allowed by the current serving grant; and
the UE has enough transmit power available to transmit at a higher data rate; and
based on the same power as the one selected in the E-DCH Transmission Format Combination, E-TFC, selection of the UE to transmit data in the same Transmission Time Interval, TTI, as the happy bit, Total E-DCH Buffer Status (TEBS) would require more than a defined number of milliseconds of delay to be transmitted with the current serving grant times the ratio of active processes to the total number of processes.

68. The Node B according to claim 66, wherein the controller is configured to take into account the setting of the second happy bit field when deciding whether to schedule more resources for uplink transmissions by the UE.
